(19) United States
(12) Patent Application Publication
(10) Pub. No.: US 2005/0036327 A1
(43) Pub. Date: Feb. 17, 2005

(54) Dynamic vehicle accent lighting system

(76) Inventor: Jet Patel, Palos Verdes Estates, CA (US)

Correspondence Address: LIU & LIU, 811 WEST SEVENTH STREET, SUITE 1100, LOS ANGELES, CA, 90017, US

(21) Appl. No.: 10/903,885

(22) Filed: Jul. 30, 2004

Related U.S. Application Data
(63) Continuation of application No. 29/191,665, filed on Oct. 10, 2003, now Pat. No. D497442.
(60) Provisional application No. 60/491,588, filed on Jul. 30, 2003.

(51) Int. Cl. B62J 6/00

(52) U.S. Cl. 362/487

(57) ABSTRACT

An accent lighting system for automobiles that includes one or more light bars, which may have a flat rectangular cross-section, and may be rigid and flexible body. A microcontroller provides control of the operation of the light bars to display various lighting patterns and sequences. In one embodiment, the controller is coupled to the audio output of the audio system in the automobile, which controls the light patterns of the light bars in reaction to audio characteristics (e.g., frequency, amplitude, etc.) of the audio output. In another embodiment, users can select different display modes through a remote control that is operated within the comfort of their automobiles. In anther aspect of the present invention, the lighting system comprises light bars that incorporate a plurality of Light Emitting Diodes (LEDs), and in particular “super-bright” LEDs, as their light source.

This application claims the priority filing date of U.S. Provisional Patent Application No. 60/491,588, filed Jul. 30, 2003; and U.S. Design Patent Application No. 29/191,665, filed Oct. 10, 2003. These applications are incorporated by reference as if fully set forth herein.

### FIELD OF INVENTION

The invention relates to a novel accent lighting system that is mounted to the underside of a vehicle to improve the aesthetics of the vehicle.

### BACKGROUND OF THE INVENTION

Automobile enthusiasts are constantly searching for ways to improve the external aesthetics of their automobiles. As a result, new products are constantly being forged to enhance the appearances of automobiles and thus, bloomed a new industry for aftermarket products that can provide external visual stimulations beyond what have been provided by the original automobile manufacturers. The marketplace consign high values on products that can attract positive attention to an automobile while simultaneously provide a unique identity that set the automobile apart from other vehicles.

Past inventions have presented ideas for external lighting systems for automobiles. U.S. Pat. No. 6,392,559 presents a lighting system that illuminates the underside of automobiles for security purposes. The lighting system consists of a plurality of individual lighting fixtures that are mounted underneath the automobile. Each lighting fixture uses a single light bulb to illuminate the ground below and around the vehicle. This approach has several disadvantages. One disadvantage is that having only one light bulb per fixture does not provide a large area of illumination, especially when the ground clearance of the automobile is small. Another disadvantage in having a pointed light source is that the illuminated area does not appear to be continuous and uniformed. Having a continuous and uniformed illuminated area is a characteristic currently desired by automobile enthusiasts. Furthermore, this lighting system uses an incandescent light bulb for its light source, which is prone to breakage of the filaments under adverse road vibrations. The aforementioned lighting system was created to brighten areas around the automobile to increase safety and deter thieves. This lighting system was not meant to improve the aesthetics of the automobiles or to attract positive attention to the automobile. As a result, the prior art lighting system is limited in its functionality to provide the automobile with a unique visual effect, which gives way to the present invention.

### SUMMARY

The present invention offers a novel lighting system that increases the aesthetics of automobiles by casting a unique colored light “curtain” or “shadow” underneath the automobile. The present invention also provides the user with the ability to change the display pattern of the light “curtain” in relation to a plurality of external signals.

In one aspect of the present invention, the light system includes one or more light bars. In one embodiment, the light bars each has a flat rectangular cross-section. The light bars may have a rigid, flexible body that allows bending to conform to surfaces to be attached.

In another aspect of the present invention, a microcontroller offers increased versatility to the user, which controls the operation of the light bars to display various lighting patterns and sequences. In one embodiment, the controller is coupled to the audio output of the audio system in the automobile, which controls the light patterns of the light bars in reaction to audio characteristics (e.g., frequency, amplitude, etc.) of the audio output. In one embodiment of the present invention, users can select different display modes through a remote control that is operated within the comfort of their automobiles.

In anther aspect of the present invention, the lighting system comprises light bars that incorporate a plurality of Light Emitting Diodes (LEDs), and in particular “super-bright” LEDs, as their light source.

### BRIEF DESCRIPTION OF DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a side view of an automobile with an embodiment lighting system with an internal audio system according to one embodiment of the present invention.

FIG. 2 is a bottom view of an automobile with the lighting system according to one embodiment of the present invention.

FIG. 3 is a block diagram of the lighting system components in accordance with one embodiment of the present invention.

FIG. 4 is a schematic view of an embodiment of the lighting system including the controller and light bars of the present invention.

FIG. 5 is a perspective view of an embodiment of a light bar according to one embodiment of the present invention.

FIG. 6 is a cross-sectional view taken along line 6-6 of the light bar in FIG. 5.

FIG. 7 is a circuit diagram of an embodiment of the controller and connected components according to one embodiment of the present invention.

FIG. 8 is a schematic illustration of a network of lighting systems in accordance with one embodiment of the present invention.

### DETAILED DESCRIPTION OF DRAWINGS

The present description is of the best presently contemplated mode of carrying out the invention. This description is made for the purpose of illustrating the general principles of the invention and should not be taken in a limiting sense. The scope of the invention is best determined by reference to the appended claims. This invention has been described herein in reference to various embodiments and drawings. It will be appreciated by those skilled in the art that variations and improvements may be accomplished in view of these teachings without deviating from the scope and spirit of the invention.

By way of illustration and not limitation, the present invention will be described in connection with a vehicle and in particular, an automobile. It will be appreciated that the invention also applies to other forms of transportation that travel close to a planar surface such as a boat, a ship, a motorcycle, a bicycle, etc. In addition, the present invention will be described in relation to a lighting system that is mounted underneath a vehicle to illuminate the ground below the vehicle. It will be appreciated by those skilled in the art that the lighting system may be also be installed on other external locations on the vehicle such as behind the front grill, inside the wheel cover, or along the sides of the boat, that can benefit from an aesthetic improvement through the use of a unique light accent. It will also be appreciated that the present invention may also be mounted inside the vehicle such as underneath the seats, below the dashboard, or under the rooftop. Moreover, the present invention will be described in connection with light bars that are hidden from the view of a casual observer. The casual observer can indirectly see the output of the light bar through the light that is reflected or scattered from the lighted area. It will be appreciated that the present invention also applies to a scheme where the light bar is visible to a casual observer and that the output of the light bar is directly viewed by the observer. For example, the present invention may be installed on top of the running board of a vehicle, on the side of the vehicle, or on the outside of the wheel of the vehicle.

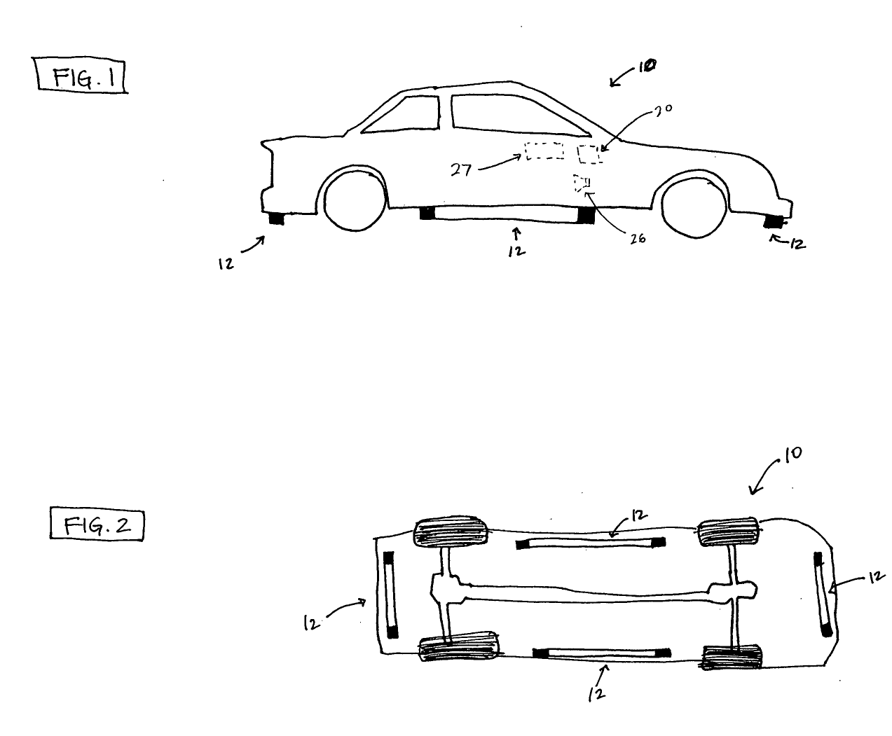

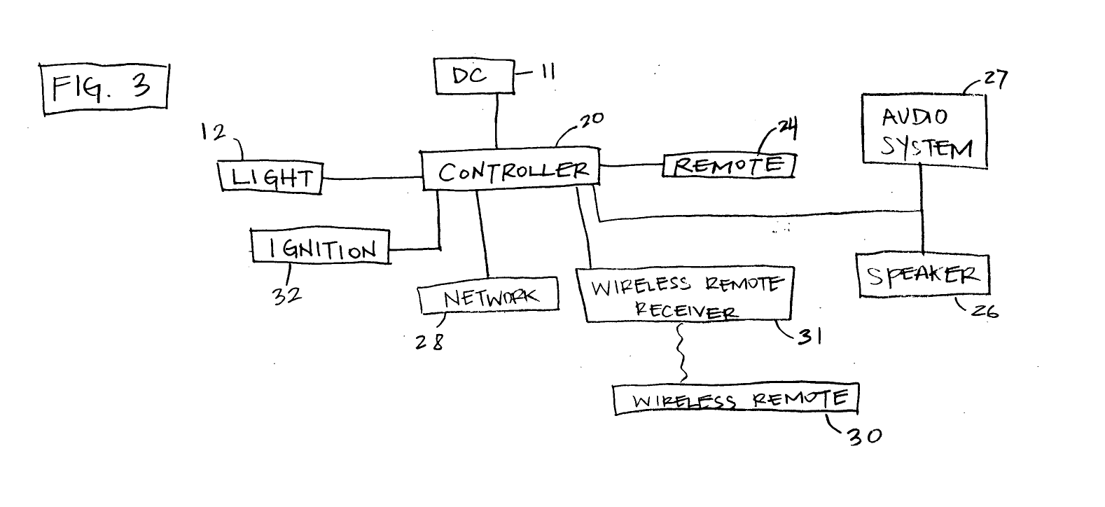

FIG. 1. represents a side view of an automobile with the external lighting system in accordance with one embodiment of the present invention. The lighting system comprises a plurality of individual slender, elongated light bars 12 that illuminate areas beneath and adjacent to the automobile 10. In FIG. 2, the view of the underside of the automobile 10 shows the light accent with four light bars 12. The light bars 12 are preferably mounted under the automobile 10 to each side of the automobile 10, including the front, rear, left side, and right side to illuminate the perimeter area beneath and adjacent to the automobile 10. There are many possible manners that the light bars 12 may be mounted onto the automobile 10. For example, the light bars 12 may be mounted and secured to the automobile through the use of straps, glue, bolts, tape, or brackets. By mounting the light bars 12 to the underside of the automobile 10, the installation provides an unobstructed path between the light source and the illuminated area resulting in relatively shadow-free illumination. In addition, installing the light bars to the underside of the automobile prevents the casual observer from directly seeing the light from the light source. The casual observer standing near the automobile will see the reflected and scattered light from the ground surrounding the automobile. The result is a pleasing light “shadow” or “curtain” that is relatively uniform in intensity and is visible to a casual observer standing near the automobile. To some observers, the lighting presents the illusion of the automobile riding on a cloud of light.

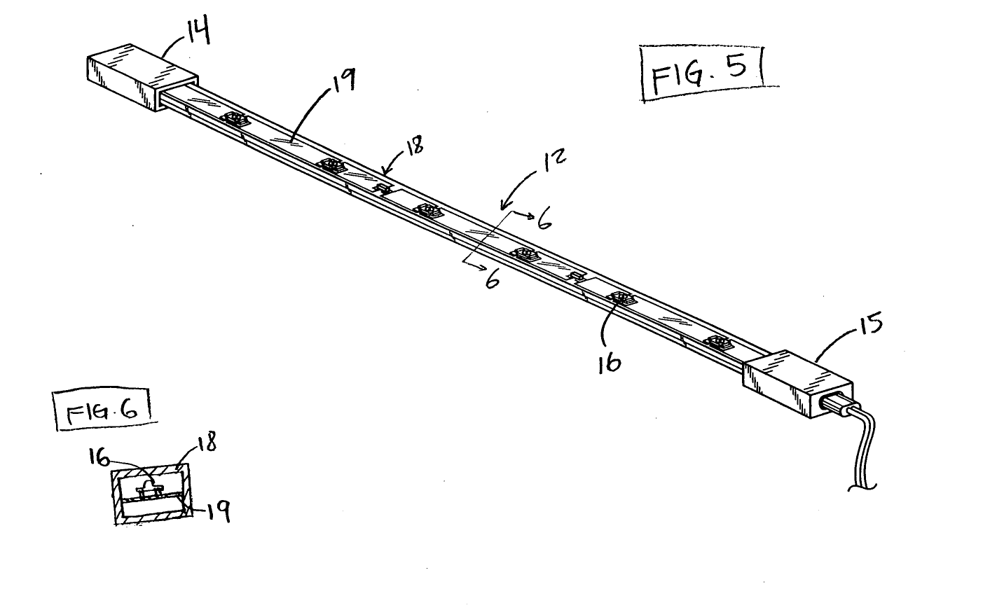

FIG. 5 illustrates one embodiment of the structure of the light bars 12. The structure is designed to withstand the harsh road environments, such as resisting attack by debris and liquids. The light bars 12 comprise a casing 18 and end stops 14, 15. The end stops 14,15 may consist of a sealant material that is debris and water resistant, such as rubber. The light bar casing 18 may be constructed of a material that is water resistant and transparent or translucent. For example, FIG. 5 illustrates a durable transparent rigid plastic casing 18.

In FIG. 5, the internal structure of the light bars 12 consists of LEDs 16 mounted on the internal circuit board 19. LEDs are an efficient light source that consumes less power during operation, which allows the present invention to be used while the vehicle is at rest (i.e. not charging its batteries). In view of the lower power consumption, it allows a plurality of LEDs to be used in each lighting bar, resulting in an increase in brightness and improvement in light uniformity that maximizes the visual stimulation provided by the present invention. Also, LEDs are sturdy solid-state devices that are ideally suited to withstand the vibration impacts associated with being mounted and operated underneath a moving automobile. The size of LEDs 16 are relatively small, thus many LEDs 16 are able to be fitted into the low profile light bar 12. The costs of LEDs 16 are relatively low compared to the costs of other lights of comparable ruggedness, efficiency, and brightness.

In one embodiment, the LEDs 16 are chosen to emit the same color (e.g., blue). It is understood that the LEDs 16 may be chosen to each emit a different color, or each light bar 12 emits a different color, if so desired.

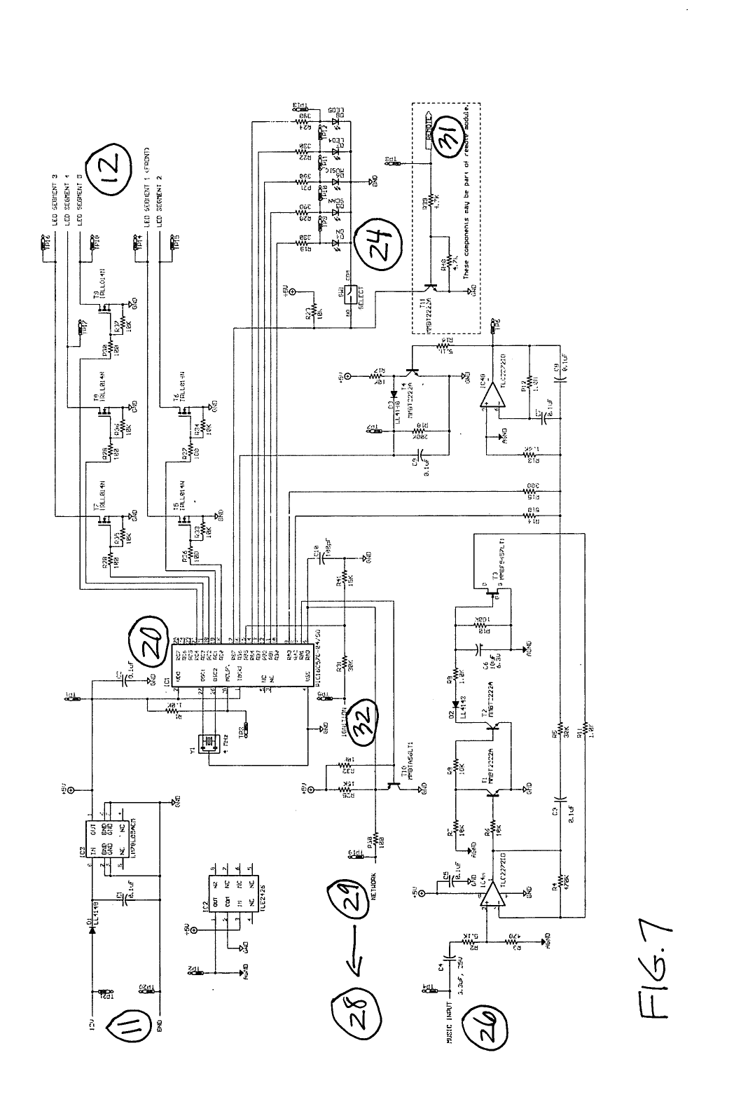

The structure of the light bars 12 may be varied in shape, size, and material. For the embodiment shown in FIG. 5, the light bars 12 have a straight tubular body with a relatively flat rectangular cross-section as shown in FIG. 6 (e.g., 0.75″ to 1″ by 0.3″ to 0.5″). The light bars may be of different tubular cross-sections, such as circular, oval, elliptical, or other symmetrical and non-symmetrical geometrical shapes. With a rectangular cross-section, using LEDs, the height profile of the light bars 12 can be reduced, thus allowing for more ground clearance when installed under the automobile. The low profile light bars 12 would also be physically less conspicuous when they are not lit. The light bars may have different lengths in a set, to suit user preferences.

The material of the light bars 12 may also vary. As mentioned earlier, the embodiment shown in FIG. 5 gives an example of a rigid plastic casing 18. The casing 18 may be constructed of a hard material, or a rigid but flexible material (e.g., a transparent polycarbonate material) such that the light bars may be bendable to conform to different shapes of the automobile underbody. By appropriately selecting the low profile of the LED based light bars, flat cross-section (e.g., 0.5″ or less), tubular wall thickness (e.g., less than 0.05″) and/or flexible material, the light bars could be structured to be easily bendable. This permits users to place the light bar 12 to conform to the surfaces to be attached at different locations on their vehicle. For instance, users may choose to install the light bars 12 in the curved wheel wells of the automobile by bending the light bars 12. Alternatively, the light bars may be structured with bendable joints (not shown) at one or more locations along the length of the light bars, such as providing serrations, bellow-shaped tubular sections, or simply weakened sections of thinner tubular wall material. With the ability to modify the shape, size, and material, automobile enthusiasts may be able to design their lighting systems to their preferences and specifications. Alternatively, the light bars may be formed of a hard or flexible plastic casing 18 that is pre-shaped to custom fit to specific locations on the automobile.

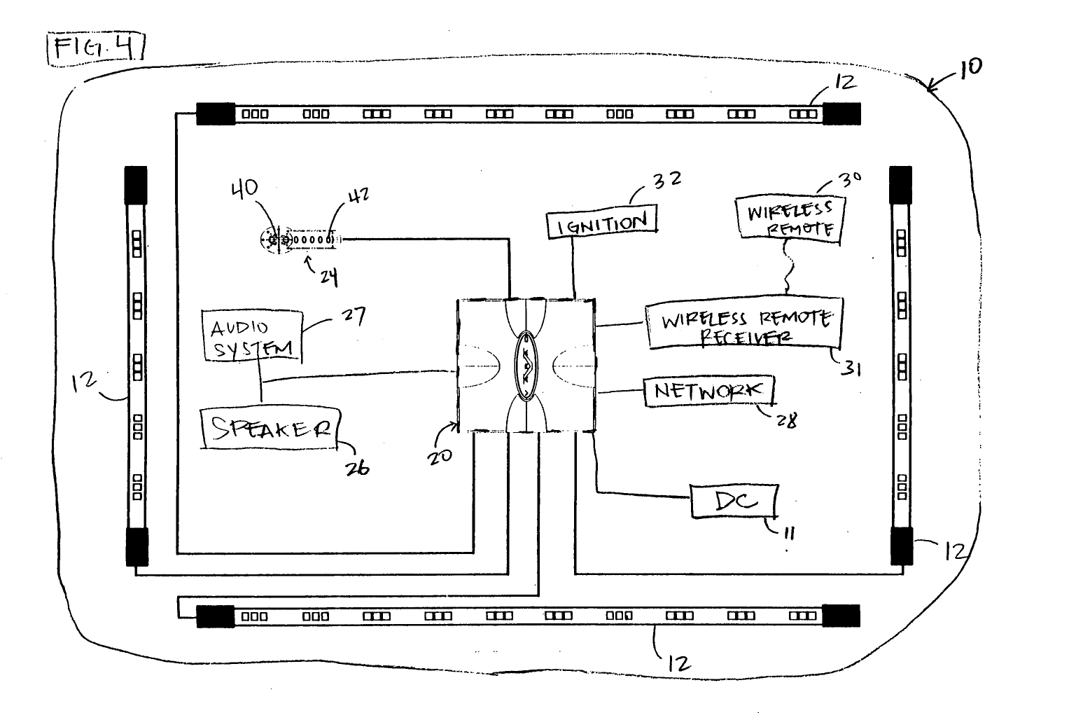

Referring to FIG. 3, the light system is powered through a connection with a shared power source 11, such as an automobile battery, or a dedicated power source such as a separate battery). In this embodiment, the automobile ignition 32 activates the power for the automobile 10 and the lighting system. After the lighting system is activated, the user has the ability to alter the illumination settings.

The present invention presents different illuminating sequences that increase the visual stimulation and enhance the attractiveness of the vehicle. There are three main modes for the lighting displays and sequences. In the first mode, the light bars 12 is controlled to remain at a solid constant illumination. The intensity level of the LEDs 16 in this mode may be adjusted by the user to increase or decrease their brightness. In the second mode, the light bars 12 can present scanning and strobe light sequences. For example, the individual LEDs 16 may be controlled to light up one at a time or constantly flash. In the third mode, the light bars 12 produce a light pattern where the light bars 12 pulsate in reaction to the output of an audio system 27. The embodiment from FIG. 1 shows the audio system 27 as an internal device located in the passenger compartment of the automobile 10. The audio system 27 is connected to the input to at least one audio speaker 26. The audio signal may be in unamplified, pre-amplified or amplified form, and the signal may be in analog, digital or optical form, depending on the type of speakers used and built-in signal processing capabilities. The controller 20 is connected to the output of the audio system 27 that provides an audio signal. The controller may include a signal processor (such as those known in the art) that can detect audio frequency, amplitude, and/or other characteristics of the audio signal. Thus the lighting system is able to display a light mode that pulsates in reaction and/or synchronization with the audio signal from the audio system, for example, in accordance with the amplitude, frequency and/or other characteristics of the audio signal.

A wired remote 24 or a wireless remote 30 (e.g., an IR or Bluetooth wireless remote) may be provided for the user to manage the display modes of the lighting system. For the embodiment in FIG. 4, users can manage the lighting system via the wired remote 24. The wired remote 24 has one button 40 with five indicator lights 42, which indicate the current light display mode and the power status for the system. The button 40 manages the settings of the controller 20. By pressing the button 40, users are able to manage the display modes and power of the lighting system. Also in FIG. 3, as an option, a wireless remote receiver 31 may be connected to the lighting system, where a wireless remote 30 may manage the display modes and power of the lighting system.

In FIG. 4, the wired remote 24, network 28, power source 11, and light bars 12 for the lighting system are all connected to the controller 20. The controller 20 is the central processing unit and controls all the parts of the lighting system. Another feature of the lighting system includes the capability to network multiple lighting systems. Users with large vehicles, such as limousines or full-size trucks, may find a lighting system with only four light bars insufficient. Thus, they may prefer the use of multiple lighting systems in order to sufficiently illuminate the ground beneath their automobiles 10. Referring to FIG. 8, the present invention allows users to couple multiple controllers 20 via network ports 29 (which may be as simple as commonly connecting a wire to the appropriate networks), to create a network 28 of lighting systems, such that users are able to control multiple light systems through a single master remote 24. The network 28 comprises multiple light systems that are connected to each other through the network port 29 provided on each controllers 20. One of the controllers 20 is designated a master controller 20a. The other controllers 20b are slave controllers. Preferrably, only the master controller 20a is provided with a master remote 24 and audio signal connection. All controllers may have power and ignition connections (not shown in FIG. 8), to improve network communication. The network system eliminates the hassle of controlling multiple remotes for the multiple light systems installed. Through the use of single remote 24 in a network 28, the user is able to control the entire networked lighting systems to display synchronized light patterns.

According to one embodiment of the present invention, the control processes and associated steps discussed above for the various embodiments may be implemented by hardware and/or software located in the controller. For example, it will be appreciated that control processes in accordance with the present invention may be supported by a controller that consists of one or more general purpose and/or application specific processors, a controller card, or an information processing system such as a computer to provide additional lighting modes or user programmable lighting modes without departing from the principles of the present invention. Referring to FIG. 4, the controller 20 is provided with the necessary functions to support the components connected thereto, to achieve the functions and features described herein. It is appreciated that specific disclosure of specific control hardware and software is not necessary to enable one skilled in the art to effectively make and use the present invention, given the disclosure of the various functions and features of the present invention.

Even though some of the embodiments use single color LEDs 16 for their light source to provide a uniform light “curtain” underneath the vehicle, the invention may also use a combination of LEDs that emit light of different wavelengths to provide more color selections to the user. For example, different colors can be achieved by using groups of red, green and blue emitting LEDs in each light bar and adjusting the intensity of each primary color (e.g. red, green or blue) in each group to create a continuous spectrum of color that can be selected by the user to match a specific color design scheme. Although some of the embodiments use LEDs for their light source due to its efficiency, ruggedness, and versatility, the invention may also use other solid-state light sources such as Organic Light Emitting Diode (OLED), Polymer Light Emitting Diode (PLED), or Electroluminescent (EL) device as the light source in the present invention.

### EXAMPLE

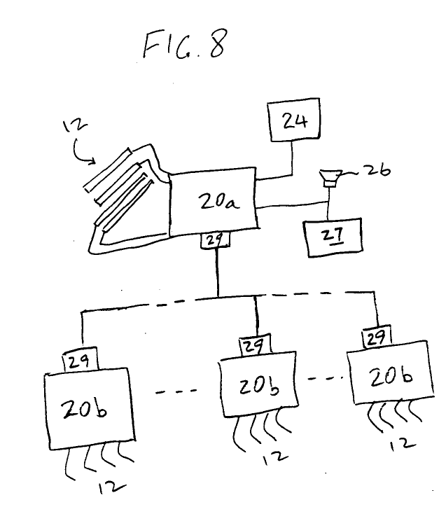

The assignee of the present application developed a particular embodiment of a lighting system generally described above, designated as Model ULS400. Below is a description of this particular embodiment to provide further details on the structure, function and features of the controller and associated components in this embodiment. FIG. 7. is a schematic circuit diagram of the controller and its connected components in accordance with one embodiment of the present invention. The circuit components are represented by symbols and nomenclature conforming to the prevailing standards in the industry. The various sections of the circuit are generally represented by circled referenced numerals corresponding to similar parts disclosed in connection with the other figures herein.

ULS400 Technical Description

General

The ULS400 is a microcontroller based lighting control device capable of operating four independent light circuits. It is intended to operate on 13.8V, or standard automotive power.

There are three modes of operation selected by a single button located on a handheld remote module. The modes are solid, scanning, and music reaction. Solid mode has four selectable intensity levels; scanning mode has many different flashing, strobing, and scanning patterns; and music mode reacts to audio input at three selectable frequency ranges.

The device is capable of networking with two or more units to provide synchronized operation.

Microcontroller

The microcontroller, U1, performs all monitoring and control functions. Scanning mode patterns are stored as tables in program memory and are accessed through table lookup routines. Intensity variation is performed by firmware PWM control of the light control outputs.

The main firmware loop is 10 mS. The loop is started with any appropriate light control output turned on. The firmware then performs overhead routines, such as monitoring the button, detecting a music input, etc. This takes a very small fraction of the 10 mS loop duration. After completing the overhead routines, the firmware enters a loop that services any PWM requirements, turning off light outputs when needed to achieve varying light intensities. The firmware then simply loops, waiting for the 10 mS duration to complete.

Single Button Control

Operation of the device is controlled by a single pushbutton. The device can detect a single button click, a double click, or an extended click as distinct operations indicating different user intent. A series of indicator LEDs on the handheld remote indicate the current device mode and operation as the button is operated.

Light Control Outputs

The light control outputs consist of five FETs, T5-T9, that switch to ground when active. Each output is capable of sinking 1.9A at a maximum of 55VDC. Typically a LED with appropriate current limiting resistor (or multiple LEDs in various configurations) would be connected to a DC supply and have it's ground connection completed through one of the output FETs.

Network

Two or more devices can be connected together through a single wire network connection. One connected device would be designated as the Master, all others would be Slaves. Operating the control button on the Master would then control all devices providing identical behavior across all devices and synchronization of any scanning patterns.

The single wire interface operates in the following manner. One device is designated as a Master. This is done by holding the control button for several seconds while the device is off (ignition line is low). The device then enters an Option mode where the device state can be changed from the default Slave to Master.

The network line is pulled high through a resistor by each device. Each device is capable of either monitoring the status of the line or pulling the line low. Each time the device is turned on by the ignition line going high, any Master will hold the network line low for a brief period. Any Slave device will monitor the network line during this time and, if a low state is sensed, will determine that the network is active and it will then cease independent operation and await commands from its Master. The process is designed such that if two devices are mistakenly designated as Masters only the first to assert the network line will dominate and any other devices designated as Masters will automatically change their status to Slave.

During operation in the networked state, the Master will send commands to all Slaves (which are connected in parallel to the common network line) each time the operation of the Master is changed. In this manner all Slaves will respond and act exactly as the Master.

The communication is accomplished over the network line by an asynchronous serial data stream of about 1200 baud. This function is accomplished by firmware in the microcontroller. During serial communication the device outputs are turned off since the data packet takes several milliseconds to transmit and a delay of this length will distort any PWM operation being performed. This delay only happens when the device mode is being changed or a scanning pattern is restarting, so it is not noticeable to the user.

Synchronization of scanning patters is insured by the Master commanding the start of each pattern cycle. The slaves only perform one scanning cycle autonomously. At the end of the cycle the Slave will await a command from the Master to start the next cycle. While the Slave is performing the scanning cycle, it will hold the network line low, and then release it when it is ready to receive the next command. The Master interprets the network line low as a sign that a Slave device is not ready to receive a new command and will wait for the network line to be released before issuing the next command.

Music

The device is capable of turning of the light control outputs in response to an audio input of the proper frequency range. Analog circuitry consisting of U2, U4 and associated circuitry conditions the audio signal for proper operation.

The audio signal is first conditioned by U4A and associated components. This is an Automatic Gain Control amplifier that keeps the voltage level of the processed input signal at a constant optimum level over an actual input voltage range of about one order of magnitude. This insures that the sensitivity of the device to audio input will be consistent over a wide volume range.

U4B and associated components form an active filter that limits the devices response to audio input of a limited frequency range. One of three frequency ranges is selected by the handheld control button.

While particular embodiments of the invention have been described herein for the purpose of illustrating the invention and not for the purpose of limiting the same, it will be appreciated by those of ordinary skill in the art that various modifications and improvements may be made without departing from the scope and spirit of the invention. Accordingly, it is to be understood that the invention is not to be limited by the specific illustrated embodiments, but only by the scope of the appended claims.

1. An accent lighting system for a vehicle, comprising:
at least one light bar; and
a controller operatively coupled to the light bar, which is configured to control light patterns of the light bar.

2. The accent lighting system of claim 1, wherein the light bar is adapted to be attached to the underside of vehicle, to cast a light on the surface beneath the vehicle.

3. The accent lighting system of claim 1, wherein the light bar has a generally rectangular cross-section.

4. The accent lighting system of claim 3, wherein the light bar has a generally low-profile flat rectangular cross-section.

5. The accent light system of claim 1, wherein the light bar has an elongated body that is rigid.

6. The accent light system of claim 1, wherein the light bar has an elongated body that is flexible to be bendable.

7. The accent light system of claim 1, wherein the controller is structured to receive an audio input, and the controller controls the light patterns of the light bar in reaction to characteristics of the audio signal.

8. The accent light system of claim 1, wherein the controller is structured to control the light patterns of the light bar in reaction to at least one of frequency characteristic and amplitude characteristic of the audio signal.

9. The accent light system of claim 1, wherein the light bar comprises a plurality of Light Emitting Diodes (LEDs).

10. The accent light system of claim 9, wherein the light bar comprises “super-bright” LEDs.

11. A vehicle, comprising:
a body having a passenger section, the body having an underbody;
at least one light bar adapted to be attached to the underbody; and
a controller operatively coupled to the light bar, which is configured to control light patterns of the light bar.

12. The vehicle as in claim 11, further comprising a remote control operatively coupled to the controller and accessible at the passenger section.

13. The vehicle as in claim 11, further comprising an audio system having an audio output, wherein the controller is structured to receive the audio input, and the controller controls the light patterns of the light bar in reaction to characteristics of the audio signal.

14. The vehicle as in claim 1, wherein the controller is structured to control the light patterns of the light bar in reaction to at least one of frequency characteristic and amplitude characteristic of the audio signal.
